(19) United States
(12) Patent Application Publication
(10) Pub. No.: US 2014/0055414 A1
(43) Pub. Date: Feb. 27, 2014

(54) TOUCH SCREEN USING INFRARED RAY, AND TOUCH RECOGNITION APPARATUS AND TOUCH RECOGNITION METHOD FOR TOUCH SCREEN

(71) Applicant: HYUNDAI MOTOR COMPANY, Seoul (KR)

(72) Inventor: Sung Un Kim, Hwaseong (KR)

(73) Assignee: Hyundai Motor Company, Seoul (KR)

(21) Appl. No.: 13/688,090

(22) Filed: Nov. 28, 2012

(30) Foreign Application Priority Data
Aug. 22, 2012 (KR) 10-2012-0091594

(51) Int. Cl. G06F 3/042

(52) U.S. Cl. CPC G06F 3/042
USPC 345/175

(57) ABSTRACT

Disclosed herein is a touch screen recognition apparatus including a resilient layer disposed on a surface of a substrate, and configured to mold according to pressure applied on the touch screen and remold to an original shape when the pressure is released. An infrared pattern layer with an infrared ray pattern is disposed on a surface of the resilient layer. A rear projection layer disposed on an opposite surface of the substrate scatters light.

### CROSS-REFERENCE

This application claims under 35 U.S.C. §119(a) the benefit of Korean Application No. 10-2012-0091594 filed Aug. 22, 2012, the entire contents of which are incorporated herein by reference.

### BACKGROUND OF THE INVENTION

1. Field of the Invention

The present invention relates to a touch screen technology, and more particularly, to a touch screen recognition apparatus and method using an infrared ray, that may recognize a curved touch on a curved or flexible display and may increase the accuracy and reliability of touch recognition.

2. Description of the Related Art

Currently, resistive, capacitive, and optical methods are typically used in touch recognition technology. An example of such a method is one based on an LCD display using a touch recognition sensor mounted onto an LCD or a touch recognition electrode.

However, the current touch recognition methods are designed to be operated on a substantially flat touch screen surface, and cannot be operated on a curved surface design such as on interior member of a vehicle. Although a curved touch screen display has been recently developed, this display is manufactured in a substantially flat surface process. Additionally, there remain physical limitations to developing a curved surface on a flexible structure. The use of an infrared camera has been suggested for both a multi-touch and a touch recognition method, but existing methods using an infrared ray are vulnerable to external noise by scattering light, causing error in touch recognition.

The foregoing is intended merely to aid in the understanding of the background of the present invention, and is not intended to mean that the present invention falls within the purview of related art that is already known to those skilled in the art.

### SUMMARY OF THE INVENTION

Accordingly, the present invention has been made in an effort to solve the above-described problems associated with prior art. The present invention proposes a touch screen recognition apparatus and method, using an infrared ray, that may operate on a curved or flexible surface, recognize a curved touch, and increase both reliability and accuracy of touch recognition.

In one aspect, the present invention discloses a touch screen using an infrared ray to recognize pressure exerted on a display. The touch screen includes a resilient layer disposed on one surface of a substrate, and is configured to mold according to pressure exerted on the touch screen and remold to an original shape when the pressure is released. The resilient layer may be formed of a transparent material. The invention further includes an infrared pattern layer including an infrared ray pattern disposed on a surface of the resilient layer. The infrared pattern may be formed such that it is not visually recognized. A rear projection layer is disposed on an opposite surface of the substrate and is configured to scatter light, effectuating a clearer image of the infrared pattern.

In another aspect, the present invention discloses a touch screen recognition apparatus including a resilient layer disposed on one surface of a substrate, and configured to mold according to pressure exerted on the display of the apparatus and remold to an original shape when the pressure is released. The invention further discloses an infrared pattern layer including an infrared ray pattern disposed on a surface of the resilient layer. In addition, a rear projection layer is disposed on an opposite surface of the substrate and is configured to scatter light, effectuating a clearer image of the infrared pattern. The image of the infrared pattern is photographed using an infrared ray camera disposed on a side of the rear projection layer. The photographed image shows a clarity change in the infrared pattern as pressure is exerted on the touch screen is touched. During the photographing step, an infrared ray illumination, disposed on a second side of the rear projection layer, irradiates an infrared ray on the infrared pattern effectuating a clearer image of the infrared pattern

In one embodiment, the touch recognition apparatus, further includes a touch recognition unit connected to the infrared ray camera. The touch recognition unit analyzes a clarity change in the infrared pattern to determine whether the touch screen is touched and the location of the touch.

In another embodiment, the touch recognition unit includes a touch recognition unit configured to set a reference clarity value of the pattern. A distance between the infrared pattern and the rear projection layer decreases as the resilient layer is pressed when pressure is exerted on the touch screen. Further, a touch manipulation is detected when the resilient layer is clearly viewed from the rear projection layer due to the pressure exerted on the touch screen. Thus, a clarity value at the touched portion of the infrared pattern is higher than the reference clarity value of the untouched portion. In addition, a location determining unit analyzes a location coordinate of the high clarity value of the infrared pattern to determine the touch location.

In yet another embodiment, the location determining unit stores a shape of the pattern and the location information of the pattern shape to analyze a location coordinate where a clarity value of the infrared pattern is improved. The clarity value is improved when the value is higher than the reference clarity value, effectuating a clearer image of the infrared pattern. Additionally, the touch recognition apparatus further includes a projector installed substantially toward the rear projection layer.

In another aspect, the present invention discloses a touch screen recognition method, including photographing an infrared pattern disposed on a surface of a resilient layer using an infrared ray camera disposed on a rear surface of a rear projection layer. Additionally, setting a reference clarity pattern of the infrared pattern and measuring a distance between the pattern and the rear projection layer. As the distance decreases when the resilient layer is pressed due to a touch, a clarity value of the touched infrared becomes higher than the reference clarity value, whereby a touch manipulation is detected. Further, analyzing a location coordinate where the clarity value of the infrared pattern is higher than the reference clarity value to determine a touch location.

According to the present invention, as an object moves closer to the rear projection layer, a clarity of an infrared pattern in the infrared ray pattern layer increases, whereby a pressure on the touch screen is recognized by photographing and analyzing the clarity change. A touch may therefore be recognized on a curved surface as on object approaches a display such as, a multimedia display device and a manipulation system. Thus, multimedia display devices may be ergonomically designed according to the location of the display in the vehicle thereby increasing device placement options.

In addition, by using a resistive touch method, a touch may be recognized through various objects such as a ball pen, a gloved hand and the like as well as a finger. Further, a touch may be recognized despite existing external optical noise, substantially increasing the reliability of the device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary view illustrating a configuration of a touch screen with a layer separation structure thereof according to an exemplary embodiment of the present invention;

FIG. 2 is an exemplary view illustrating a clarity change of an infrared pattern corresponding to a touch manipulation of the touch screen according to an exemplary embodiment of the present invention;

FIG. 3 is an exemplary view illustrating a clarity change principle corresponding to an increment of interval according to an exemplary embodiment of the present invention; and

FIG. 4 is an exemplary view illustrating an example of a pattern shape formed in an infrared pattern layer according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF PREFERRED EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings.

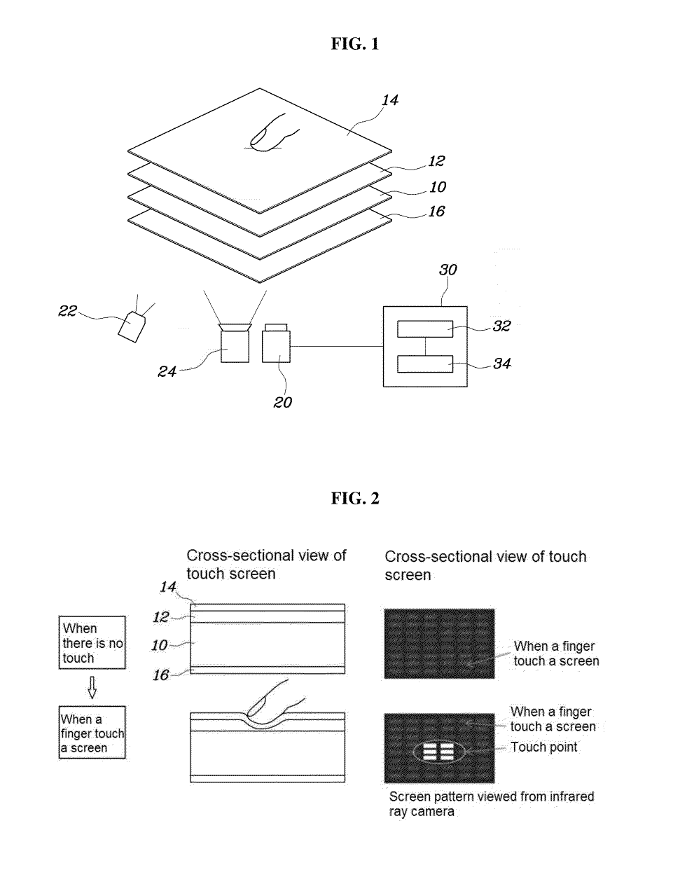

A touch screen using an infrared ray according to the present invention illustrated with reference FIGS. 1 to 4, includes a resilient layer 12 disposed on a surface of a substrate 10, and is configured to mold when pressure is exerted on the touch screen and remold to an original shape when the pressure is released. An infrared pattern is formed on an infrared pattern layer 14 which is disposed on a surface of the resilient layer 12. Further, a rear projection layer 16 is disposed on an opposite surface of the substrate 10 and is configured to scatter light. Here, the resilient layer 12 may be formed of a transparent material, and when pressure is exerted on the touch screen, the infrared pattern formed in the infrared ray pattern layer 14 may be photographed using an infrared ray camera 20. In addition, the infrared ray pattern layer 14, the resilient layer 12, and the rear projection layer 16 may take the form of a film.

In particular, as illustrated in FIG. 4, the infrared pattern, used to detect a touch, may be formed in various shapes such as a line, a point, and a barcode. In addition, the pattern formed in the infrared pattern layer 14 is visually unrecognizable, decreasing noise in the pattern image that may be displayed in the substrate 10.

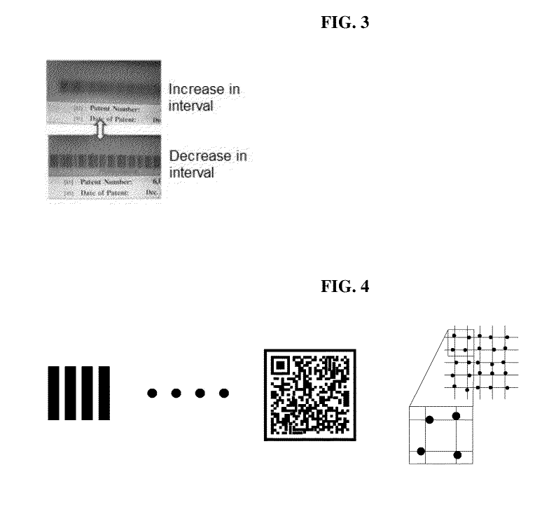

Further, the rear projection layer 16 has a light scattering property in its material characteristics, and allows an image projected from a projector 24 to be viewed from the exterior surrounding of the touch screen. In addition, the light scattering property allows clarity differences between a touched and an untouched portion of the infrared pattern to be viewed through the infrared ray camera 20. That is, as illustrated in FIG. 3, as the pattern moves closer to the rear projection layer 16, the pattern image becomes more clear on a rear surface of the rear projection layer 16. In contrast, as the pattern becomes more distant from the rear projection layer 16, the pattern image becomes more blurry, whereby the clarity value of the pattern changes.

Meanwhile, as illustrated in FIG. 1, a touch screen recognition apparatus of the present invention includes, a resilient layer 12 disposed on a surface of a substrate 10, and configured to mold according to pressure applied to the touch screen and remold to an original shape when the pressure is released. In addition, an infrared pattern layer 14 with an infrared ray pattern is disposed on a surface of the resilient layer 12. A rear projection layer 16 is disposed on an opposite surface of the substrate 10 and is configured to scatter light. Further, an infrared ray camera 20, disposed on a side of the rear projection layer 16, photographs a clarity value change of the infrared pattern formed in the infrared ray pattern layer 14 when the touch screen is touched. An infrared ray illumination 22 is disposed on a second side of the rear projection layer 16, and irradiates an infrared ray to photograph the infrared pattern by the infrared ray camera 20. Here, the infrared ray illumination 22 may be an infrared ray light-emitting diode (LED).

Further, a projector 24 may be installed substantially toward the rear projection layer 16, and the projector 24 projects an image to the rear projection layer 16, viewable from the exterior surroundings of the touch screen. That is, when pressure is exerted on the touch screen, the infrared ray pattern layer 14 is pressed closer to the rear projection layer 16, pushing the resilient layer 12 towards the rear projection layer 16. An infrared pattern passes through the rear projection layer 16 and forms on the infrared pattern layer 14. Then, the projection camera 20 photographs the infrared pattern as the pattern approaches the rear projection layer 16, causing a clarity value change. Further, as the infrared ray illumination 22 irradiates infrared ray to the infrared ray pattern layer 14 through the rear projection layer 16, a clarity change of the infrared pattern may be photographed through the infrared ray camera 20.

An apparatus for touch screen recognition may further include a touch recognition unit 30 connected to the infrared ray camera 20, configured to analyze a clarity change of the infrared pattern to determine touch and touch location. In detail, the touch recognition unit 30 may include a touch recognition unit 32 configured to set a reference clarity value of the infrared pattern. To detect a touch manipulation, a distance between the pattern and the rear projection layer 16 is measured. A touch is determined when the distance decreases as the resilient layer 12 is pressed and the infrared pattern 12 is clearly viewed from the rear projection layer 16. Thus, a clarity value of the infrared pattern at the touched portion is higher than the reference clarity value of the untouched portion. Further, a location determining unit 34 is configured to analyze a location coordinate where the infrared pattern clarity value becomes substantially high to determine a touched location.

That is, as illustrated in FIGS. 2 and 3, when the infrared ray pattern layer 14 moves closer to the rear projection layer 16 due to pressure on the touch screen, an infrared pattern image of the touched portion is photographed more clearly than the untouched portions. Thus, pressure exerted on the touch screen is detected when an infrared pattern has a higher clarity value than the reference clarity value. Further, a location of a touch manipulation may be determined by analyzing a location coordinate of the infrared pattern where the clarity value has been improved, wherein an improved clarity value produces a clearer infrared pattern image. In addition, the location determining unit 34 may store a pattern shape and the pattern shape location information to analyze a location coordinate where a clarity value of the pattern has been improved.

In particular, as described above, the infrared pattern in the infrared ray pattern layer 14 may be formed in various shapes, and location information for each portion of the pattern shape is stored in the location determining unit 34. Thus, when a clarity value of at least a portion of the pattern is improved, a location of the touched portion may be recognized by analyzing a location coordinate of the infrared pattern portion having an improved clarity value.

Furthermore, a touch recognition method of the present invention includes photographing an infrared pattern disposed on a surface of a resilient layer 12 through an infrared ray camera 20 disposed on a rear surface of a rear projection layer 16. Additionally, the invention includes setting a reference clarity value of the infrared pattern. A touch manipulation is determined when a distance between the infrared pattern and the rear projection layer 16 decreases as pressure is exerted on the touch screen. The shorter distance allows the touched portion of the infrared pattern to be viewed more clearly from the rear projection layer 16. Thus, a clarity value of the infrared pattern at the touched portion becomes higher than the reference clarity value. Further a location of the touched portion is determined by analyzing a location coordinate of the portion where the clarity value of the pattern has substantially increased.

Accordingly, when pressure is exerted on the touch screen, a touch is recognized by detecting a clarity of an infrared pattern increasing higher than the reference clarity value. This change in clarity value occurs as a distance between the infrared pattern and the rear projection layer 16 decreases. Thus, a multimedia display device as well as a manipulation system may be designed and manufactured as a curved display depending on a user's convenience. The display face may be ergonomically designed, increasing the placement options of the device in a vehicle.

In addition, by using a resistive touch method for recognizing pressure on a touch screen 10, a touch manipulation by various objects such as a ball pen, a gloved hand, a finger, and the like may be recognized. Furthermore, a touch may be recognized despite existing external optical noise, significantly increasing the reliability of the device.

Although the preferred embodiments of the present invention have been disclosed for illustrative purposes. those skilled in the art will appreciate that various modifications, additions, and substitutions are possible without departing from the scope and spirit of the invention as disclosed in the accompanying claims.

What is claimed is:

1. A touch screen, comprising:
a resilient layer disposed on a surface of a substrate, configured to mold according to pressure applied on the touch screen and remold to an original shape when the pressure is released;
an infrared pattern layer disposed on a surface of the resilient layer wherein the infrared pattern layer includes an infrared ray pattern; and
a rear projection layer disposed on an opposite surface of the substrate and configured to scatter light.

2. The touch screen of claim 1, wherein the resilient layer is formed of a transparent material.

3. The touch screen of claim 1, wherein the infrared ray pattern formed in the infrared pattern layer is visually unrecognizable.

4. A touch screen recognition apparatus, comprising:
a resilient layer disposed on a surface of a substrate, and configured to mold according to pressure applied on the touch screen and remold to an original shape when the pressure is released;
an infrared pattern layer disposed on a surface of the resilient layer and wherein the infrared pattern layer includes an infrared ray pattern;
a rear projection layer disposed on an opposite surface of the substrate and configured to scatter light;
an infrared ray illumination disposed on a first side of the rear projection layer, and configured to irradiate an infrared ray onto the infrared pattern; and
an infrared ray camera disposed on a second side of the rear projection layer, and configured to photograph a clarity change of the infrared pattern formed when the touch screen is touched.

5. The touch recognition apparatus of claim 4, further including:
a touch recognition unit connected to the infrared ray camera, and configured to analyze the clarity change of the infrared pattern to determine the pressure on the touch screen;
a location recognition unit connected to the touch recognition unit and configured to analyze the location of pressure on the touch screen.

6. The touch recognition apparatus of claim 5, wherein the touch recognition unit includes:
setting, by the touch recognition unit, a reference clarity value of the infrared pattern;
measuring a distance between the infrared pattern and the rear projection layer wherein a shorter distance indicates pressure on the touch screen; and
determining a touch manipulation by detecting the clarity change of the reference clarity value wherein a clarity value of the infrared pattern is higher than the reference clarity value.

7. The touch recognition apparatus of claim 5, wherein the location recognizing unit stores an infrared pattern shape and a location information of the infrared pattern shape to analyze a location coordinate where the clarity value of the infrared pattern is improved.

8. The touch recognition apparatus of claim 4, further including:
a projector disposed substantially toward the rear projection layer.

9. A touch screen recognition method, comprising:
photographing, by an infrared ray camera, an infrared pattern disposed on a surface of a resilient layer;
setting a reference clarity pattern of the infrared pattern;
detecting a touch manipulation when a distance between the pattern and the rear projection layer 16 decreases wherein a clarity value of the infrared pattern is higher than the reference clarity value; and
analyzing a location coordinate of the portion where the clarity value of the infrared pattern is higher than the reference clarity value, configured to determine a touch location.
